(19) United States
(12) Patent Application Publication
(10) Pub. No.: US 2015/0061219 A1
(43) Pub. Date: Mar. 5, 2015

(54) IMAGE FORMING APPARATUS

(71) Applicant: CANON KABUSHIKI KAISHA, Tokyo (JP)

(72) Inventors: Atsushi Murakami, Kawasaki-shi (JP); Daisuke Aoki, Yokohama-shi (JP)

(21) Appl. No.: 14/467,381

(22) Filed: Aug. 25, 2014

(30) Foreign Application Priority Data
Aug. 30, 2013 (JP) 2013-178990

(51) Int. Cl. B65H 1/14; F16H 1/28; B65H 7/20; B65H 1/04; B65H 5/06

(52) U.S. Cl. CPC B65H 1/14; B65H 1/04; B65H 5/068; B65H 7/20; F16H 1/28
USPC 271/272; 271/147

(57) ABSTRACT

One aspect of the present invention provides an image forming apparatus that can prevent degradation of sheet feeding performance at low cost. A drive transmission portion 200B is provided between a driving motor 227 that drives a conveying roller 250 provided in an apparatus body and a body-side lifting portion 200C that drives a lifter mechanism 200A of a sheet feeding cassette 201 mounted on the apparatus body. When the sheet feeding cassette 201 is mounted on the apparatus body, the drive transmission portion 200B selectively transmits drive of the driving motor 227 to the lifter mechanism 200A through the body-side lifting portion 200C to lift a stacking plate 206 by a predetermined amount.

### BACKGROUND OF THE INVENTION

1. Field of the Invention

The present invention relates to an image forming apparatus, particularly to a configuration lifting a sheet stacking portion on which a sheet is stacked.

2. Description of the Related Art

A conventional image forming apparatus such as a printer, a copying machine, and a facsimile machine includes a sheet feeding device in which a sheet stored in a sheet storage unit drawably provided in an image forming apparatus body is delivered and fed to an image forming portion by a sheet feeding unit. In some sheet feeding devices, a sheet stacking unit is provided in the sheet storage unit so as to be able to be lifted and lowered, and the sheet is fed by rotating a pickup roller while the sheet stacking unit is lifted to press the sheet against the pickup roller.

In the sheet feeding device, it is necessary to hold a level of the uppermost sheet stacked on sheet stacking unit at a predetermined level at which the sheet can be fed. For this reason, the sheet feeding device includes a sensing unit that senses an upper-surface position of the sheet stacked on the sheet stacking unit and a lifter mechanism that lifts the sheet stacking unit. The sheet stacking unit is lifted by driving the lifter mechanism based on a signal from the sensing unit to hold the level of the uppermost sheet at the predetermined level at which the sheet can be fed by the pickup roller.

A driving portion (driving unit) that drives the lifter mechanism is provided in the image forming apparatus body, and the lifter mechanism is coupled to the driving portion when the sheet storage unit is mounted. This enables the lifter mechanism to lift the sheet stacking unit based on the sensing of the sensing unit. The driving portion includes a dedicated lifter motor that drives the lifter mechanism (see Japanese Patent Laid-Open No. 9-86680 and 5-193761).

However, in the conventional image forming apparatus, cost increases because the dedicated lifter motor is used to drive the lifter mechanism, and the number of components increases for the use of the dedicated lifter motor. When component accuracy varies, a lifting amount of the sheet stacking unit fluctuates to generate a variation in level of the uppermost sheet, which degrades sheet feeding performance.

It is desirable to provide an image forming apparatus that can prevent the degradation of the sheet feeding performance at low cost.

### SUMMARY OF THE INVENTION

According to one aspect of the invention, an image forming apparatus includes: an image forming portion that forms an image on a sheet; a sheet storage portion that is drawably mounted on an apparatus body, the sheet storage portion including a sheet stacking portion that stacks a sheet and is able to be lifted and lowered and a lifting portion that lifts the sheet stacking portion; a sheet feeding portion that feeds a sheet while abutting the sheet on a sheet stacked on the lifted sheet stacking portion; a driving portion that drives a driven portion; a body-side lifting portion that is provided in the apparatus body to engage with the lifting portion of the sheet storage portion mounted on the apparatus body; a drive transmission portion that is provided between the driving portion and the body-side lifting portion, the drive transmission portion selectively transmitting drive of the driving portion to the lifting portion of the sheet storage portion through the body-side lifting portion to lift the sheet stacking portion, the drive of the driving portion being transmitted to the driven portion; and a controller that controls the drive transmission portion.

According to the invention, the drive transmission portion selectively transmits the drive of the driving portion driving the driven portion to the lifting portion of the sheet storage portion through the body-side lifting portion to lift the sheet stacking portion. Therefore, the degradation of the sheet feeding performance can be prevented at low cost.

Further features of the present invention will become apparent from the following description of exemplary embodiments with reference to the attached drawings.

### BRIEF DESCRIPTION OF THE DRAWINGS

FIG. 1 is an entire configuration diagram of a full-color laser beam printer that is of an example of an image forming apparatus according to a first embodiment of the invention;

FIG. 2 is a view illustrating a configuration of a sheet feeding device of the full-color laser beam printer;

FIGS. 3A and 3B are views illustrating a configuration of a sheet feeding cassette of the sheet feeding device;

FIGS. 4A and 4B are views illustrating a configuration of a drive transmission portion provided on a main body side of the full-color laser beam printer;

FIG. 5 is a control block diagram of the sheet feeding device;

FIGS. 6A and 6B are first views illustrating stacking plate lifting operation of the sheet feeding device;

FIG. 7 is a view illustrating operation in lifting a stacking plate of the drive transmission portion;

FIGS. 8A and 8B are second views illustrating the stacking plate lifting operation of the sheet feeding device;

FIG. 9 is a view illustrating a configuration of the sheet feeding device provided in an image forming apparatus according to a second embodiment of the invention;

FIGS. 10A and 10B are views illustrating a missing tooth gear constituting the drive transmission portion lifting the stacking plate of the sheet feeding cassette of the sheet feeding device;

FIG. 11 is a view illustrating the operation in lifting the stacking plate of the drive transmission portion;

FIG. 12 is a view illustrating a configuration of the sheet feeding device provided in an image forming apparatus according to a third embodiment of the invention;

FIGS. 13A and 13B are views illustrating a planetary gear unit constituting the drive transmission portion lifting the stacking plate of the sheet feeding cassette of the sheet feeding device; and

FIGS. 14A and 14B are views illustrating the operation in lifting the stacking plate of the drive transmission portion.

### DESCRIPTION OF THE EMBODIMENTS

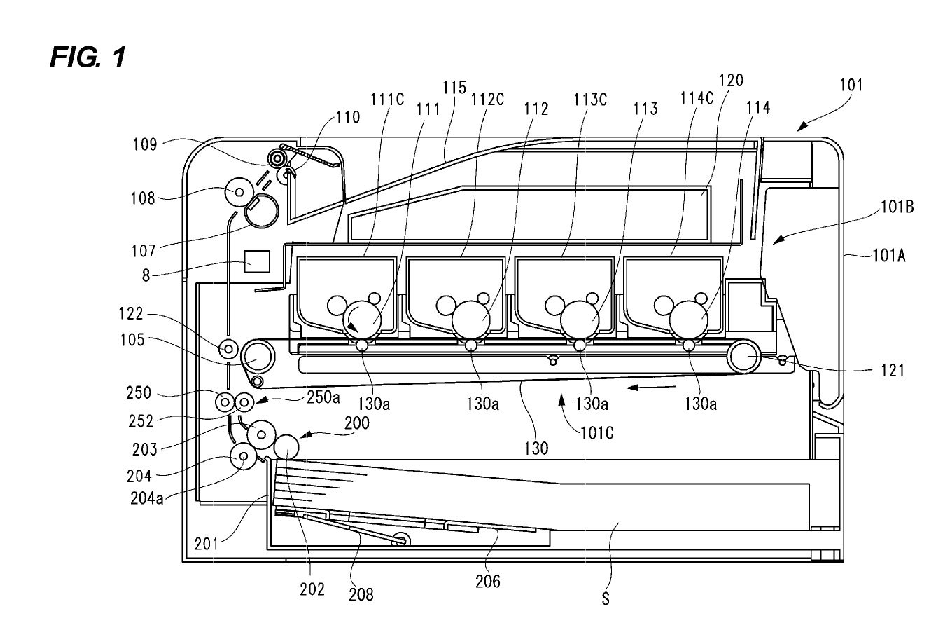

Hereinafter, exemplary embodiments of the invention will be described in detail with reference to the drawings. FIG. 1 is an entire configuration diagram of a full-color laser beam printer 101 that is of an example of an image forming apparatus according to a first embodiment of the invention. An image forming portion 101B forming an image on a sheet S such as recording paper, a plastic sheet, and a cloth and a sheet feeding device 200 feeding the sheet S are provided in a full-color laser beam printer body 101A (hereinafter referred to as a printer body) that is of an apparatus body.

The image forming portion 101B includes process cartridges 111C, 112C, 113C, and 114C that form four color toner images of yellow, magenta, cyan, and black. The process cartridges 111C, 112C, 113C, and 114C include photosensitive drums 111, 112, 113, and 114, and are drawably mounted on the printer body 101A. The image forming portion 101B also includes a laser scanner unit 120. The laser scanner unit 120 is arranged immediately above the process cartridges 111C, 112C, 113C, and 114C, and irradiates the photosensitive drums 111, 112, 113, and 114 with a laser beam based on image information.

An intermediate transfer belt unit 101C in FIG. 1 includes an endless intermediate transfer belt 130 and primary transfer rollers 130a each of which is provided inside the intermediate transfer belt 130 while opposed to the photosensitive drums 111, 112, 113, and 114. The intermediate transfer belt 130 is entrained about a driving roller 121, a secondary transfer counter roller 105, and the like, and rotates in an arrow direction while abutting on all the photosensitive drums 111, 112, 113, and 114.

The primary transfer roller 130a presses the intermediate transfer belt 130 to form a primary transfer portion in which the intermediate transfer belt 130 abuts on the photosensitive drums 111, 112, 113, and 114, and the primary transfer roller 130a applies a transfer bias to the intermediate transfer belt 130 using a bias applying unit (not illustrated). When the primary transfer roller 130a applies the primary transfer bias to the intermediate transfer belt 130, the color toner images on the photosensitive drums 111, 112, 113, and 114 are sequentially transferred to the intermediate transfer belt 130 to form a full color image on the intermediate transfer belt 130.

On an outer circumferential surface side of the intermediate transfer belt 130, a secondary transfer roller 122 is arranged at a position opposed to the secondary transfer counter roller 105. The secondary transfer roller 122 comes into pressure contact with the secondary transfer counter roller 105 with the intermediate transfer belt 130 interposed therebetween, thereby forming a secondary transfer portion. The toner image on the intermediate transfer belt 130 is transferred to the sheet S (secondary transfer) by applying a bias having an opposite-polarity to a normal charging polarity of toner to the secondary transfer roller 122 from a secondary transfer bias power supply (not illustrated) that is of a secondary transfer bias applying unit.

The sheet feeding device 200 includes a sheet feeding cassette 201 and a pickup roller 202. The sheet feeding cassette 201 is the sheet storage portion that is drawably mounted on the printer body 101A. The pickup roller 202 is the sheet feeding portion that delivers the sheet S stored in the sheet feeding cassette 201. A stacking plate (sheet supporting plate) 206 is provided in the sheet feeding cassette 201 so as to be able to be lifted and lowered. The stacking plate 206 is the sheet stacking portion that presses the stored sheet S against the pickup roller 202 while supporting the sheet S. In feeding the sheet S stored in the sheet feeding cassette 201, the stacking plate 206 is lifted by a lifting mechanism (to be described later), and the sheet S supported by the stacking plate 206 is pressed against the pickup roller 202.

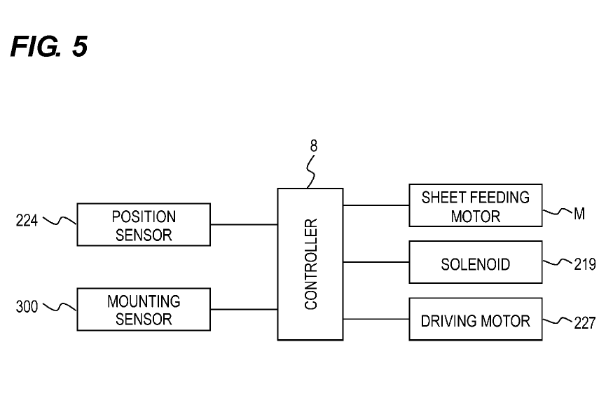

The pickup roller 202 is rotated while the sheet S is pressed against the pickup roller 202, thereby delivering the sheet S. In FIG. 1, a controller 8 controls image forming operation and sheet feeding operation. For example, the controller 8 controls drive of a sheet feeding motor M (to be described later) in FIG. 5 that drives the pickup roller 202 and drive of a constraining mechanism (to be described later) during the feed of the sheet S.

The image forming operation of the full-color laser beam printer 101 having the above configuration will be described below. In the case that the color image is formed on the sheet, the photosensitive drums 111, 112, 113, and 114 of the process cartridges 111C, 112C, 113C, and 114C are rotated counterclockwise at a predetermined control speed. According to the drum rotations, the intermediate transfer belt 130 is also rotated at a speed corresponding to the speeds of the photosensitive drums 111, 112, 113, and 114 in a direction indicated by an arrow, and the laser scanner unit 120 is also driven at the substantially same time.

In synchronization with the drive, photosensitive drum surfaces are evenly charged in the process cartridges 111C, 112C, 113C, and 114C. Then, the laser scanner unit 120 performs exposure to the photosensitive drums 111, 112, 113, and 114 based on each color component image signal sent from the controller 8. Therefore, electrostatic latent images are formed on the photosensitive drum surfaces.

Then, the process cartridges 111C, 112C, 113C, and 114C develop the electrostatic latent images of magenta, yellow, cyan, and black using color toners to form the toner images on the photosensitive drums 111, 112, 113, and 114. When the toner images reach transfer regions where the photosensitive drums 111, 112, 113, and 114 abut on the intermediate transfer belt 130 according to the rotations of the photosensitive drums 111, 112, 113, and 114, the primary transfer roller 130a applies the primary transfer bias. Therefore, the toner images on the photosensitive drums 111, 112, 113, and 114 are transferred onto the intermediate transfer belt 130 in the order of magenta, yellow, cyan, and black according to the rotation of the intermediate transfer belt 130, and the color toner images are formed on the intermediate transfer belt 130.

On the other hand, in parallel with the color toner image forming operation, the controller 8 drives the sheet feeding motor M to rotate the pickup roller 202 in predetermined sequence control timing, whereby the sheet S is delivered from the sheet feeding cassette 201 to reach a nip portion between a feed roller 203 and a retard roller 204. At this point, when only one sheet S is delivered, a large rotational torque is applied through the sheet S to the retard roller 204 that forms a separation nip portion together with the feed roller 203. For this reason, by action of a torque limiter (not illustrated) arranged in a driving shaft 204a of the retard roller 204, the retard roller 204 rotates while dragging the conveyed sheet S.

In the case that at least two sheets S are delivered from the pickup roller 202, a driving force is transmitted to the retard roller 204 through the torque limiter because only a frictional force between the sheets S is transmitted to the retard roller 204. Therefore, the retard roller 204 rotates reversely, one sheet S on the side of the feed roller 203 is left, and all the remaining sheets S are returned in a direction opposite to a sheet feeding direction, which allows the sheet S to be surely separated and delivered one by one.

The sheet S separated one by one by the separation nip portion is delivered to a nip portion of a pair of conveying rollers 250a including a conveying roller 250 that is of a driving roller and a driven roller 252. Then the sheet S is delivered to the secondary transfer portion including the secondary transfer counter roller 105 and the secondary transfer roller 122. In the secondary transfer portion, the color toner images on the intermediate transfer belt are collectively transferred onto the sheet S by the transfer bias applied to the secondary transfer roller 122.

Then, the sheet S to which the color toner images are transferred is separated from the intermediate transfer belt 130, and delivered to a nip portion between a fixing film 107 and a pressure roller 108. In the nip portion, the sheet S is subjected to heating and pressurization, thereby fixing the color toner images onto the sheet S. Then, a pair of discharge rollers 109 and 110 discharges the sheet S to which the color toner images are fixed onto a discharge tray 115 provided on a top surface of the printer body 101A.

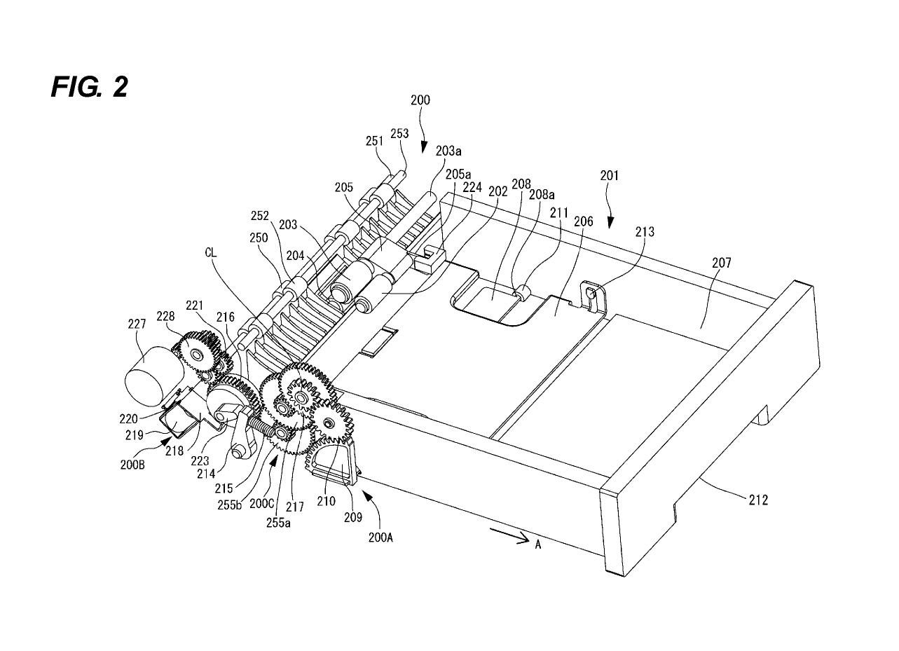

FIG. 2 is a view illustrating a configuration of the sheet feeding device 200 of the first embodiment. In FIG. 2, a support member 205 is vertically swingable with a shaft 203a of the feed roller 203 as a support point, and the pickup roller 202 is turnably supported by the support member 205. In the first embodiment, the pickup roller 202, the feed roller 203, and the retard roller 204 are rotated by the drive of sheet feeding motor M.

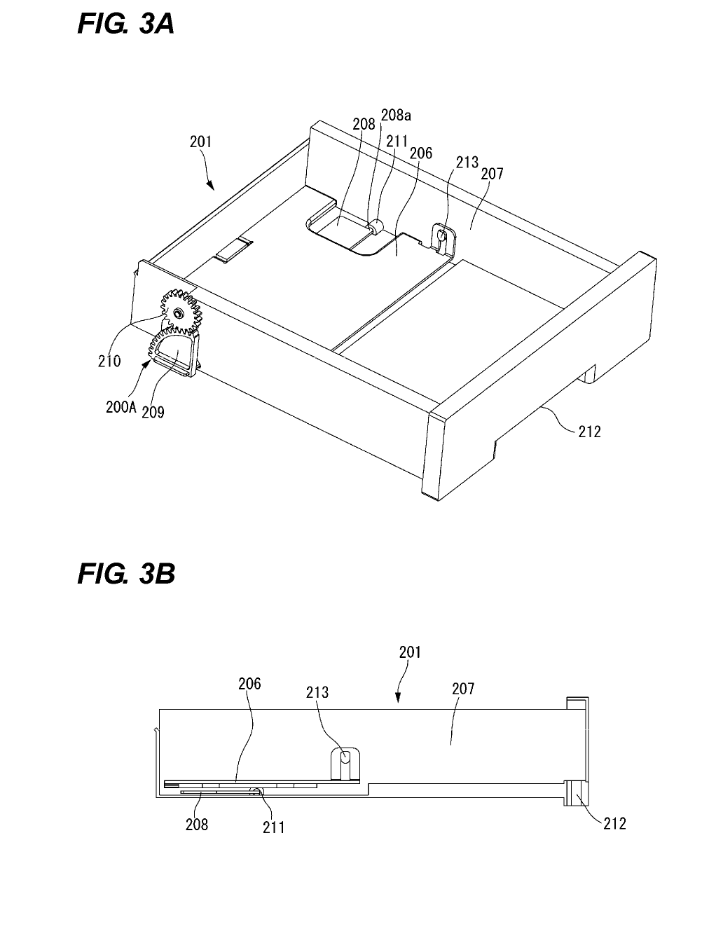

A support shaft 213 is provided in a cassette body 207 of the sheet feeding cassette 201, and a downstream end side of the stacking plate 206 turns vertically about the support shaft 213 as illustrated in FIGS. 3A and 3B. In FIGS. 2 and 3A and 3B, a lifter plate 208 is a turning member that lifts the stacking plate 206, and the lifter plate 208 turns vertically while a lifter shaft 208a that is of a turning shaft is supported by a bearing 211 provided in the cassette body 207.

A lifter gear 209 that is of a lifting gear is fixed to the lifter shaft 208a of the lifter plate 208. When the lifter gear 209 rotates in an arrow direction, the lifter plate 208 turns about the lifter shaft 208a to lift the stacking plate 206. A cassette interface gear 210 engaging with the lifter gear 209 is provided in the sheet feeding cassette 201. In the first embodiment, a lifter mechanism 200A that is of the lifting portion lifting the stacking plate 206 includes the lifter plate 208, the lifter gear 209, and the cassette interface gear 210.

In the configuration of the first embodiment, a dedicated driving source such as a motor driving the lifter mechanism 200A is not provided, but the lifter mechanism 200A is driven by a driving source used in another mechanism of the full-color laser beam printer 101. In FIG. 2, a driving motor 227 is the driving portion as another mechanism. The driving motor 227 drives the conveying roller 250 that is of the sheet conveying portion as an example of the driven portion. The driving motor 227 drives the lifter mechanism. 200A. The drive of the driving motor 227 is transmitted to a stage gear 228 and a lifter mechanism driving gear 221 attached to a roller shaft 251 of conveying roller 250, whereby the conveying roller 250 and the driven roller 252 rotate.

A drive transmission portion 200B transmits the drive of the driving motor 227 to the lifter mechanism 200A through a body-side lifting unit 200C when the sheet feeding cassette 201 is mounted on the printer body 101A. The body-side lifting unit 200C engages with the lifter mechanism 200A when sheet feeding cassette 201 is mounted. The body-side lifting unit 200C includes lift driving stage gears 255a and 255b and an interface gear 217 engaging with the cassette interface gear 210.

The drive transmission portion 200B is provided between the driving motor 227 and the body-side lifting unit 200C, and includes an idler gear 220 engaging with the lifter mechanism driving gear 221. The drive transmission portion 200B also includes a missing tooth gear 216. The missing tooth gear 216 is provided between the idler gear 220 and the lift driving stage gear 255b to selectively transmit the rotation of the idler gear 220 to the interface gear 217 through the lift driving stage gears 255a and 255b. A solenoid 219 is the switching unit that switches the missing tooth gear 216 between a state in which the drive of the driving motor 227 is not transmitted to the body-side lifting unit 200C and a state in which the drive of the driving motor 227 is transmitted to the body-side lifting unit 200C.

A cassette handle 212 is provided in the cassette body 207. A user holds the cassette handle 212 to draw the sheet feeding cassette 201 in the direction of arrow A, which allows the user to stack the sheet S. The engagement between the cassette interface gear 210 and the interface gear 217 is uncoupled when the sheet feeding cassette 201 is drawn.

A position sensor 224 constitutes a sensing unit that senses whether a position of the sheet S on the stacking plate 206 reaches a position (predetermined range) in a level direction in which the pickup roller 202 can feed the sheet S. The position sensor 224 is a photosensor. The position sensor 224 outputs an on/off signal according to the position of the support member 205, and the controller 8 (to be described later) senses whether the position of the sheet S on the stacking plate 206 reaches a sheet feedable range of the pickup roller 202 based on the on/off signal. In the first embodiment, the sheet feedable position is set to an optimum range where the sheet S delivered by the pickup roller 202 can proceed into the nip portion between the feed roller 203 and the retard roller 204.

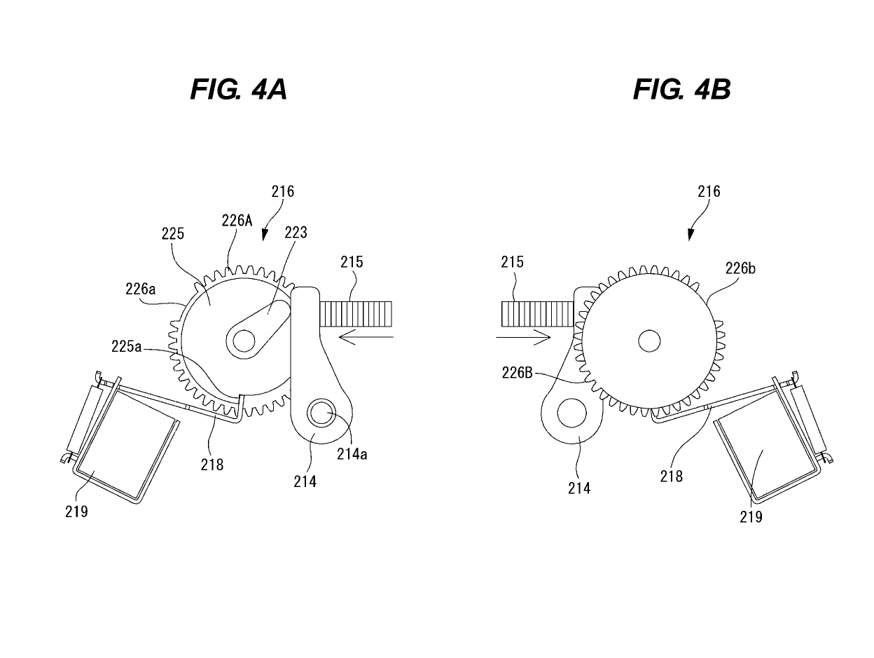

As illustrated in FIG. 4A, a first missing tooth gear portion 226A, a trigger cam portion 223, and a missing tooth gear constraining cam portion 225 are provided in the missing tooth gear 216 constituting the drive transmission portion 200B. A second missing tooth gear portion 226B is also provided in the missing tooth gear 216 as illustrated in FIG. 4B that is of a view when the missing tooth gear 216 is viewed from the side opposite to FIG. 4A. That is, the first missing tooth gear portion 226A and the second missing tooth gear portion 226B, which differ from each other in a thickness direction, are provided in the missing tooth gear 216.

When the solenoid 219 constrains the rotation, the missing tooth gear 216 stops at the position where a missing tooth 226a of the first missing tooth gear portion 226A faces the idler gear 220 in FIG. 2. At this point, the missing tooth gear 216 also stops at the position where a missing tooth 226b of the second missing tooth gear portion 226B faces the lift driving stage gear 255b in FIG. 2.

As illustrated in FIG. 4A, a lever 214 is in pressure contact with the trigger cam portion 223 of the missing tooth gear 216. The lever 214 is turnably provided in the printer body 101A with a shaft 214a as the support point, and the lever 214 is biased toward an arrow direction by a lever pressing spring 215. A hook portion 225a is provided in a circumferential surface of the missing tooth gear constraining cam portion 225 of the missing tooth gear 216 in order to latch a constraining member 218 of the solenoid 219.

For example, FIGS. 4A and 4B illustrate the state before starting of the sheet feeding operation. At this point, the constraining member 218 of the solenoid 219 is latched in the hook portion 225a, and therefore the rotation of the missing tooth gear 216 is constrained even if the trigger cam portion 223 is pressed by the lever 214. As described later, when the solenoid 219 is turned on, the latch of the constraining member 218 is released, and the missing tooth gear 216 is pressed by the lever 214 that is in pressure contact with the trigger cam portion 223, whereby the missing tooth gear 216 rotates.

FIG. 5 is a control block diagram of the sheet feeding device 200. The controller 8 is connected to the sheet feeding motor M, the driving motor 227, the solenoid 219, the position sensor 224, and a mounting sensor 300 sensing that the sheet feeding cassette 201 is mounted on the printer body 101A.

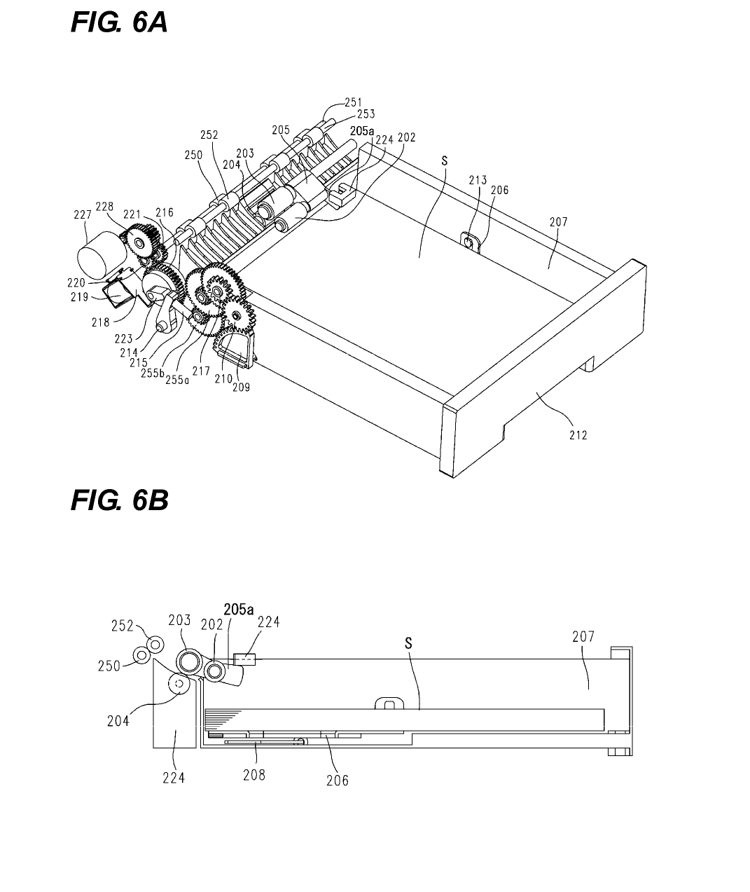

The stacking plate lifting operation of the sheet feeding device 200 having the above configuration will be described below. FIGS. 6A and 6B illustrate an initial state when the sheet feeding cassette 201 is mounted on the printer body 101A. At this point, a top surface of the sheets S stored in the sheet feeding cassette 201 is separated from the pickup roller 202. Therefore, in order to feed the sheet S, it is necessary to lift the stacking plate 206 to the sheet feedable position of the pickup roller 202 to press the sheet S against the pickup roller 202.

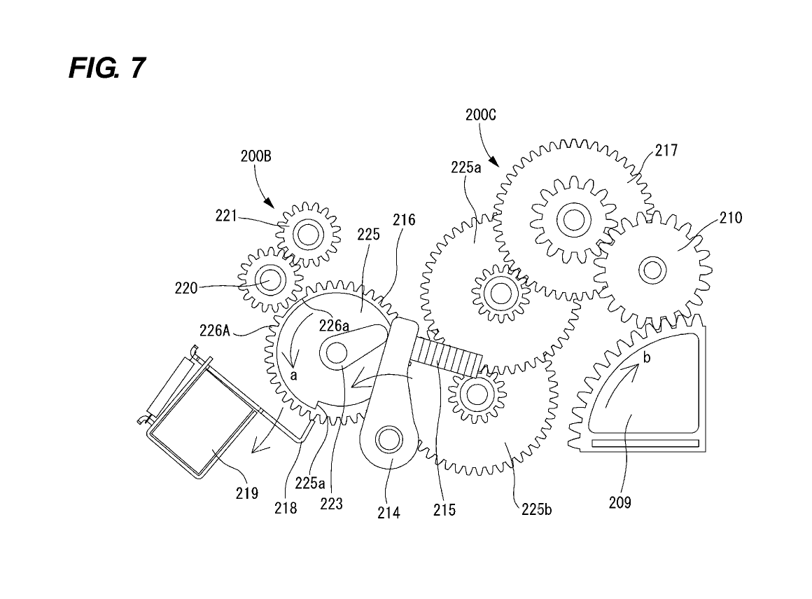

When a signal is input to the controller 8 from the mounting sensor 300 sensing that the sheet feeding cassette 201 is mounted on the printer body 101A, the controller 8 rotates the driving motor 227 in order to rotate the stage gear 228 and the lifter mechanism driving gear 221 engaging with the stage gear 228, whereby the conveying roller 250 and the driven roller 252 rotate. When the lifter mechanism driving gear 221 rotates, the idler gear 220 engaging with the lifter mechanism driving gear 221 rotates as illustrated in FIG. 7. However, at this point, the drive of the idler gear 220 is not transmitted to the missing tooth gear 216, because the idler gear 220 rotates at the position facing the missing tooth 226a of the first missing tooth gear portion 226A of the missing tooth gear 216.

At the time the feed of the sheet S is started, the controller 8 applies a voltage to the solenoid 219. Therefore, the constraining member 218 of the solenoid 219 moves in an arrow direction in FIG. 7, and trips from the hook portion 225a of the missing tooth gear constraining cam portion 225 to release the constraint of the rotation of the missing tooth gear 216. At this point, because the missing tooth gear 216 is pressed through the trigger cam portion 223 by the lever 214 biased by the lever pressing spring 215, the missing tooth gear 216 rotates in the direction of an arrow a in FIG. 7 when the constraint of the rotation is released.

When the missing tooth gear 216 rotates, the idler gear 220 engages with the missing tooth gear 216, whereby the missing tooth gear 216 is rotated by the idler gear 220. When the missing tooth gear 216 rotates, (the second missing tooth gear portion 226B of) the missing tooth gear 216 engages with the lift driving stage gear 255b, and the lift driving stage gear 255b starts to rotate. The rotation of the lift driving stage gear 255b is transmitted to the lifter gear 209 through the lift driving stage gear 255a, the interface gear 217, and the cassette interface gear 210, and the lifter gear 209 rotates in the direction of an arrow b.

Therefore, the lifter plate 208 turns upward with the bearing 211 as the support point, and the stacking plate 206 is pushed up about the support shaft 213 to lift the sheet S. Immediately after the sheet feeding cassette 201 is mounted, it is necessary that the sheet S stacked on the stacking plate 206 move over a long distance to the sheet feedable position. For this reason, the controller 8 continuously applies the voltage to the solenoid 219 to rotate the missing tooth gear 216, and the stacking plate 206 is continuously lifted.

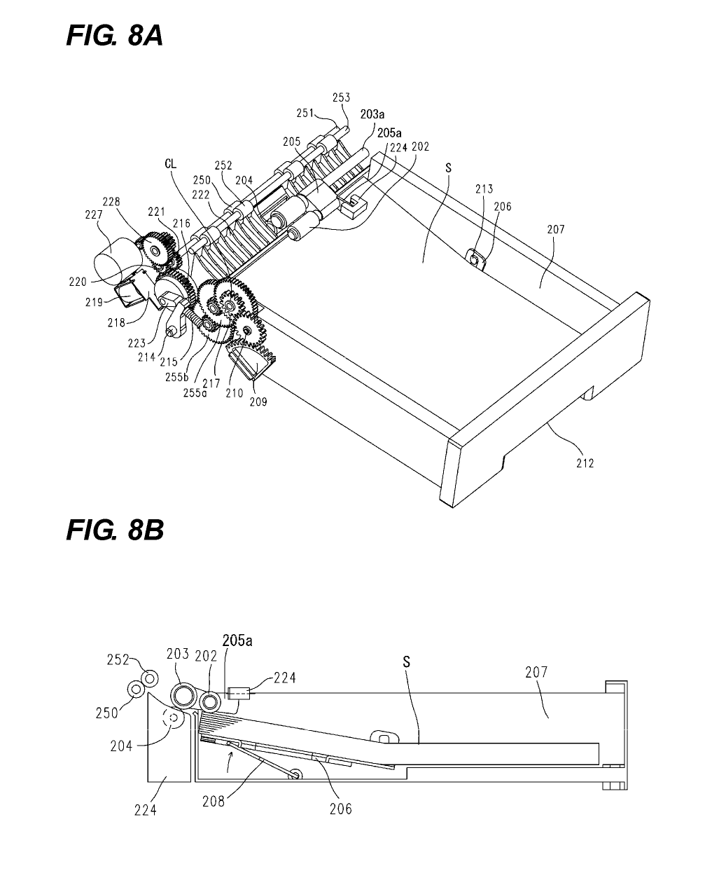

Then, as illustrated in FIGS. 8A and 8B, when the sheet S on the stacking plate 206 abuts on the pickup roller 202, the pickup roller 202 and the support member 205 turn upward with the shaft 203a of the feed roller 203 as the support point. When the position sensor 224 senses a flag portion 205a provided in the upwardly-turned support member 205, the controller 8 stops the voltage application to the solenoid 219.

When the voltage application to the solenoid 219 is stopped, as illustrated in FIGS. 4A and 4B, the constraining member 218 is latched in the hook portion 225a of the missing tooth gear constraining cam portion 225 to constrain the rotation of the missing tooth gear 216, which stops the stacking plate 206 at the sheet feedable position of the pickup roller 202. When the rotation of the missing tooth gear 216 is constrained, a torque acts on the lifter gear 209 in the direction opposite to the arrow b in FIG. 7 by loads of the stacking plate 206 and the sheet S. However, because a one-way clutch CL is provided in the interface gear 217 in order to prevent the reverse rotation, the one-way clutch CL does not rotate the lifter gear 209, but the stacking plate 206 is held at the stopping position.

After the stacking plate 206 is lifted to the sheet feedable position, the controller 8 drives the sheet feeding motor M to rotate the pickup roller 202, thereby feeding the sheet S. At this point, the level of the top surface of the sheets S decreases gradually when the sheet S is repeatedly fed. With decreasing level of the top surface, the flag portion 205a of the support member 205 turns downward together with the pickup roller 202, and the position sensor 224 becomes a transmissible state. At this point, the controller 8 applies the voltage to the solenoid 219 based on the signal from the position sensor 224.

A time for which the voltage is applied to the solenoid 219 is set within a time for one revolution of the missing tooth gear 216. Accordingly, a rotation amount of the lifter gear 209 is kept constant because a constant amount of drive is transmitted to the lifter gear 209. As described above, in the first embodiment, in the case that the sheets S are continuously fed, the constraint of the missing tooth gear 216 is released for a constant time with the solenoid 219 based on the signal from the position sensor 224, whereby the rotation amount of the lifter gear 209 is kept constant. As a result, the stacking plate 206 can be lifted by a predetermined amount, and the top surface of the sheets S can be held at the substantially constant level.

At this point, in the first embodiment, a reduction ratio of a gear train from the missing tooth gear 216 to the lifter gear 209 is set to 0.0308, the number of teeth of the first missing tooth gear portion 226A of the missing tooth gear 216 is set to 36, the number of teeth of the second missing tooth gear portion 226B is set to 3, and the drive is transmitted onto the downstream side. Because of the settings of the numbers of teeth, the lifter gear 209 rotates by 0.833° every time the constraining member 218 is released, and the stacking plate 206 is lifted by a constant amount (about 1 mm). When a predetermined number of sheets S are fed, the constraining member 218 is released to lift the stacking plate 206 by about 1 mm (predetermined amount) at the abutment part between the uppermost surface of the stacked sheets S and the feed roller 203.

As described above, in the first embodiment, when the sheet feeding cassette 201 is mounted, the missing tooth gear 216 is continuously rotated until the sheet S on the stacking plate 206 reaches the sheet feedable position based on the sensing of the position sensor 224. When a predetermined number of sheets S are fed during the continuous feed of the sheets S, the missing tooth gear 216 rotates once, and the stacking plate 206 is lifted by the predetermined amount. Thus, the drive of the driving motor 227 is selectively transmitted to the lifter gear 209 in order to drive the driven portion, which allows the stacking plate 206 to be lifted by the predetermined amount without use of the dedicated lifter motor. That is, in the first embodiment, the drive transmission portion 200B selectively transmits the drive of the driving motor 227 driving the driven portion to the body-side lifting unit 200C in order to lift the stacking plate 206. Therefore, the degradation of the sheet feeding performance can be prevented at low cost.

In the first embodiment, the missing tooth gear 216 rotates once to lift the stacking plate 206 in the case that the sheets S are continuously fed. Alternatively, for example, the time for which the voltage is applied to the solenoid 219 is increased, and the missing tooth gear 216 may rotate twice or three times to increase a lifting amount of the stacking plate 206. The lifting amount of the stacking plate 206 per rotation of the missing tooth gear 216 can be set to a desired amount except 1 mm by changing the reduction ratio of the gear train or the number of missing teeth of the missing tooth gear 216. The motor used as the driving portion driving the lifter mechanism 200A is not limited to the driving motor 227 driving the conveying roller 250 that is of the driven portion. Alternatively, for example, a motor driving the intermediate transfer belt 130 that is of the driven portion in the image forming portion may be used.

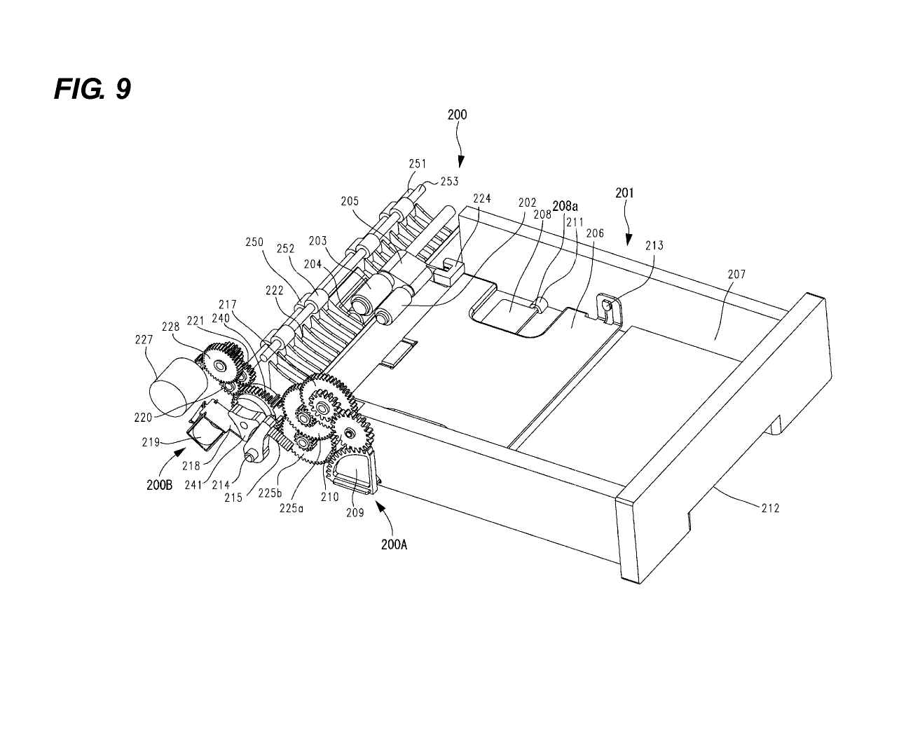

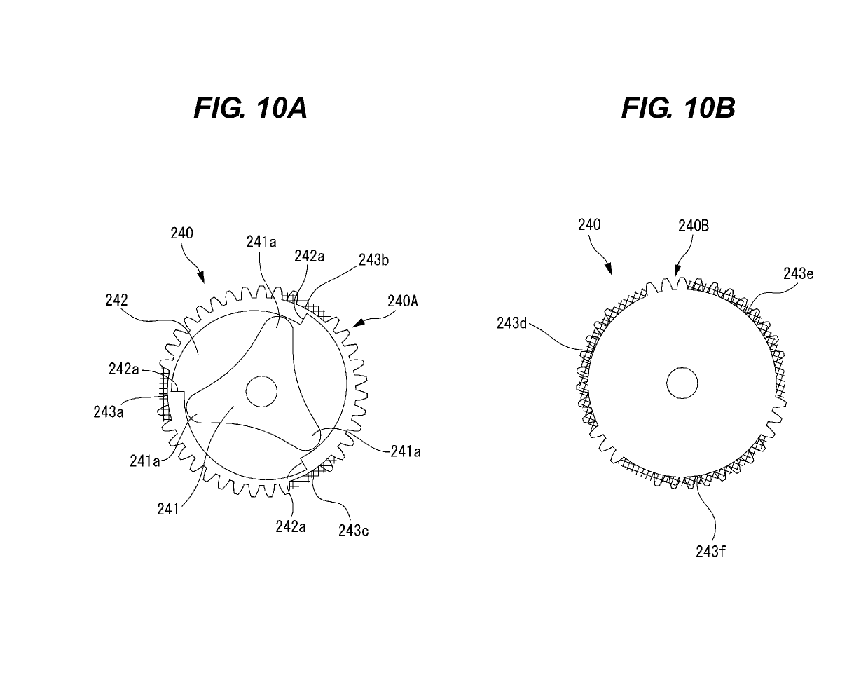

A second embodiment of the invention will be described below. FIG. 9 is a view illustrating a configuration of the sheet feeding device provided in an image forming apparatus according to a second embodiment of the invention. In FIG. 9, the component identical or equivalent to that in FIG. 2 is designated by the identical numeral. Referring to FIG. 9, a missing tooth gear 240 constitutes the drive transmission portion 200B. As illustrated in FIG. 10A, a trigger cam portion 241 and a constraining cam portion 242 are provided in the missing tooth gear 240.

In the second embodiment, in the trigger cam portion 241, three pressing places 241a are provided in the rotation direction. In the constraining cam portion 242, three hook portions 242a for the constraining member 218 are provided, and a first missing tooth gear portion 240A is provided in order to engage intermittently with the idler gear 220. The first missing tooth gear portion 240A includes three missing teeth 243a, 243b, and 243c.

As illustrated in FIG. 10B in which the missing tooth gear 240 is viewed from the side opposite to FIG. 10A, a second missing tooth gear portion 240B is provided in the missing tooth gear 240 in order to engage intermittently with the missing tooth gear lift driving stage gear 255b. The second missing tooth gear portion 240B includes three missing teeth 243d, 243e, and 243f. That is, in the missing tooth gear 240, the first missing tooth gear portion 240A and the second missing tooth gear portion 240B are provided in the thickness direction.

The lifting operation of the stacking plate 206 of the sheet feeding device 200 having the above configuration will be described below. When the signal is input to the controller 8 from the mounting sensor 300 sensing that the sheet feeding cassette 201 is mounted on the printer body 101A, the controller 8 rotates the driving motor 227 to rotate the lifter mechanism driving gear 221.

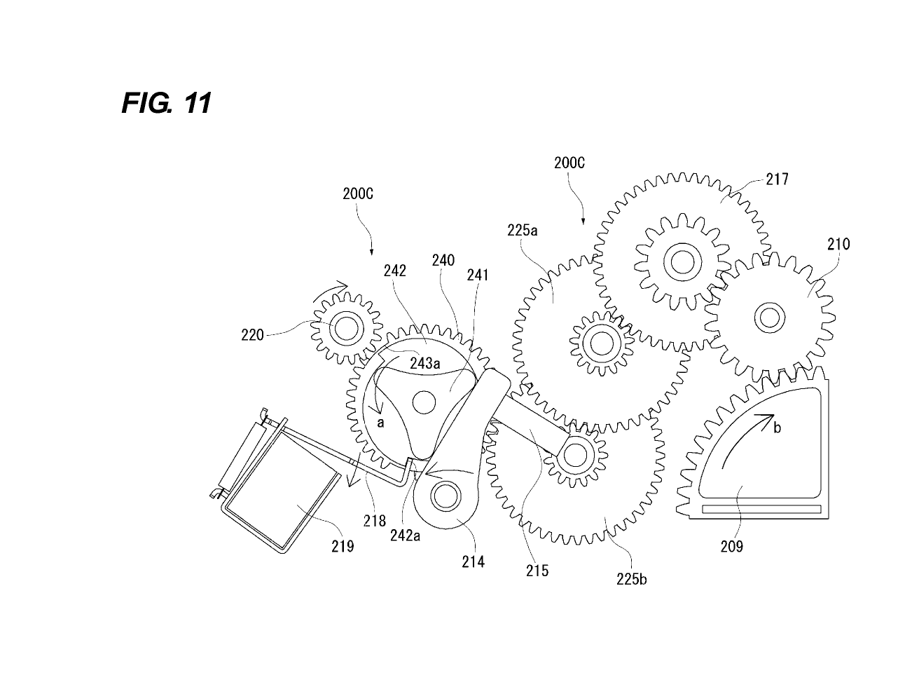

Therefore, the conveying roller 250 and the driven roller 252 rotate. When the lifter mechanism driving gear 221 rotates, the idler gear 220 engaging with the lifter mechanism driving gear 221 rotates in the arrow direction in FIG. 11. However, at this point, the drive is not transmitted to the missing tooth gear 240 because the idler gear 220 rotates at the position facing one of the three missing teeth 243a, 243b, and 243c of the first missing tooth gear portion 240A, for example, at the position facing the missing tooth 243a.

Then, the controller 8 applies the voltage to the solenoid 219 at the time the feed of the sheet S is started, whereby the constraining member 218 of the solenoid 219 disengages from the hook portion 242a of the constraining cam portion 242 to release the constraint of the rotation of the missing tooth gear 240. At this point, one of the three pressing place 241a provided in the trigger cam portion 241 of the missing tooth gear 240 is pushed by the lever 214 biased by the lever pressing spring 215. Therefore, the missing tooth gear 240 rotates in the direction of the arrow a when the constraint of the rotation is released.

When the missing tooth gear 240 rotates, the idler gear 220 engages with the missing tooth gear 240, and therefore the missing tooth gear 240 is rotated by the idler gear 220. Thus, when the missing tooth gear 240 rotates, the missing tooth gear 240 engages with the lift driving stage gear 255b to start the rotation of the lift driving stage gear 255b. The rotation of the lift driving stage gear 255b is transmitted to the lifter gear 209 through the lift driving stage gear 255a, the interface gear 217, and the cassette interface gear 210 to rotate the lifter gear 209 in the direction of the arrow b.

Therefore, the lifter plate 208 turns upward with the bearing 211 as the support point, and the stacking plate 206 is pushed up about the support shaft 213 to lift the sheet S. Immediately after the sheet feeding cassette 201 is mounted, it is necessary that the stacking plate 206 move over a long distance to the sheet feedable position. For this reason, the controller 8 continuously applies the voltage to the solenoid 219 to lift the stacking plate 206.

After the stacking plate 206 is lifted to the sheet feedable position, the controller 8 drives the sheet feeding motor M to rotate the pickup roller 202, thereby feeding the sheet S. When the sheet S is repeatedly fed, the level of the top surface of the sheets S decreases gradually. With decreasing level of the top surface, the flag portion 205a of the support member 205 turns downward together with the pickup roller 202, and the position sensor 224 eventually becomes the transmissible state. At this point, the controller 8 applies the voltage to the solenoid 219 based on the signal from the position sensor 224.

At this point, in the second embodiment, the time for which the voltage is applied to the solenoid 219 is set within the time for one third of the one revolution of the missing tooth gear 240. Even if the voltage application time is set in the above manner, because the hook portions 242a are provided at three places in the constraining cam portion 242, the missing tooth gear 240 stops when rotating one third of one revolution. Thus, in the second embodiment, in the case that the sheets S are continuously fed, the missing tooth gear 240 rotates one third to lift the stacking plate 206, which allows the lifting amount of the stacking plate 206 to be decreased during the one-time lifting control of the stacking plate 206.

In the second embodiment, the reduction ratio of the gear train from the missing tooth gear 240 to the lifter gear 209 is set to 0.0308, each second missing tooth gear portion 240B is arranged at an angle of 120°, and three teeth are provided in each second missing tooth gear portion 240B. The time for which the voltage is applied to the solenoid 219 is set within the time for one third of one revolution of the missing tooth gear 240 to release the constraining member 218, whereby the lifter gear 209 rotates by 0.833°. Therefore, the stacking plate 206 is lifted by about 1 mm in the abutment part between the uppermost surface of the stacked sheets S and the feed roller 203.

As described above, in the second embodiment, the stacking plate 206 is lifted by rotating the missing tooth gear 240 one third of one revolution, namely before the missing tooth gear 240 rotates once. Accordingly, the stacking plate 206 can be lifted without rotating the missing tooth gear 240 once, and the time for which the voltage is applied to the solenoid 219 can be shortened.

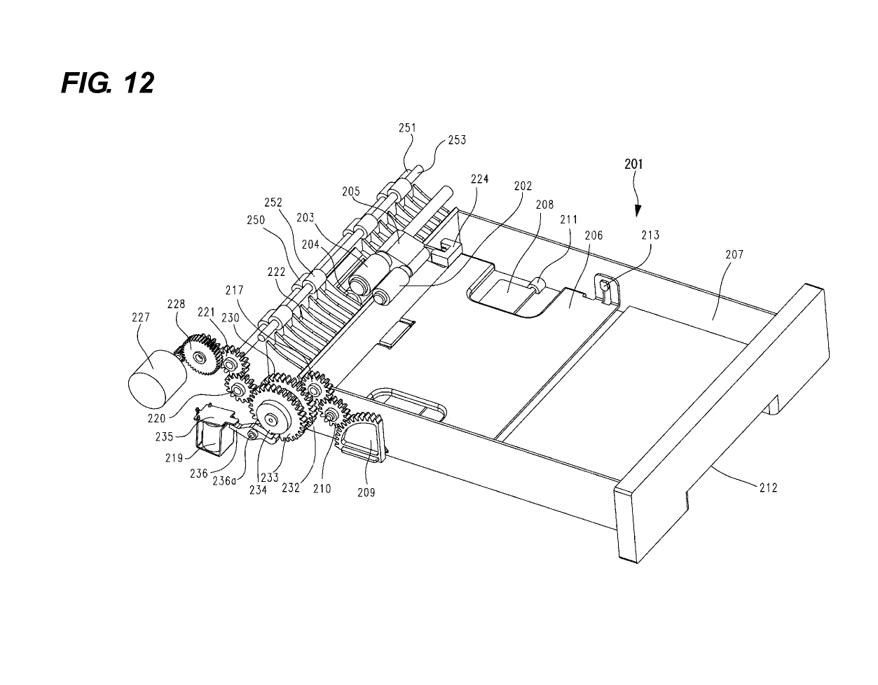

A third embodiment of the invention will be described below. FIG. 12 is a view illustrating a configuration of a sheet feeding device according to a third embodiment of the invention. In FIG. 12, the component identical or equivalent to that in FIG. 2 is designated by the identical numeral. Referring to FIG. 12, a planetary gear unit (planetary gear mechanism) 230 constitutes the drive transmission portion 200B. A switching lever 236 that is of the switching unit is swingably provided in the printer body 101A with a shaft 236a as the support point, and the switching lever 236 switches a drive transmission state of the planetary gear unit 230. The solenoid 219 performs the switching of the switching lever 236.

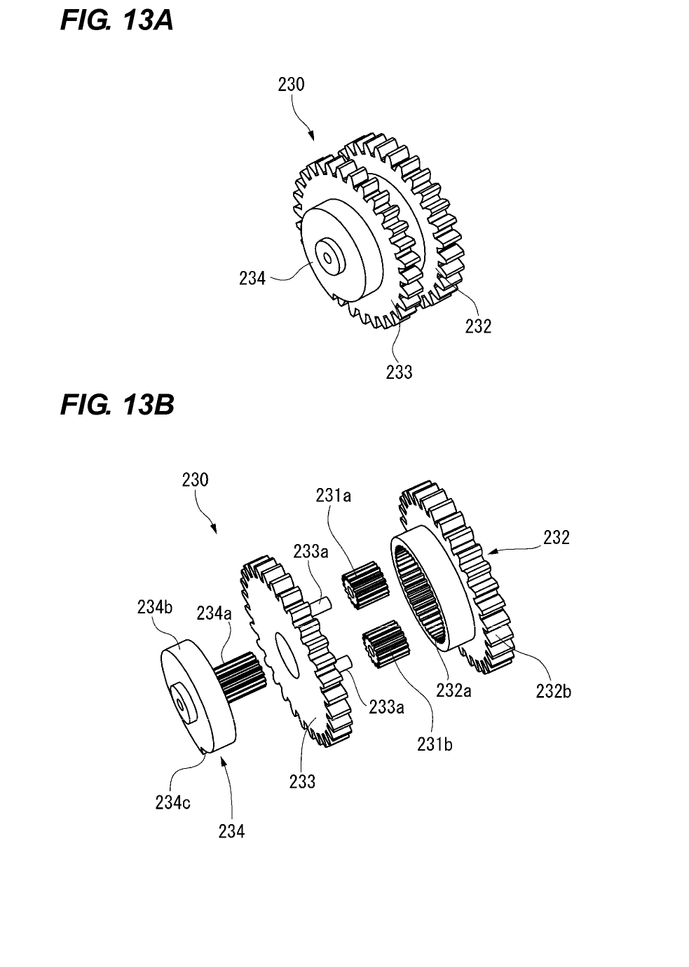

As illustrated in FIGS. 13A and 13B, the planetary gear unit 230 includes planetary gears 231a and 231b, an internal gear 232, a carrier gear 233, and a sun gear 234. In the third embodiment, the carrier gear 233 is the input side of the planetary gear unit 230, and the internal gear 232 is the output side. That is, the carrier gear 233 engages with the idler gear 220, and the internal gear 232 engages with the interface gear 217.

The sun gear 234 includes a gear portion 234a and a cam portion 234b. A hook portion 234c is provided in a circumferential surface of the cam portion 234b, and shaft portions 233a are provided at two places in the carrier gear 233 in order to turnably support the planetary gears 231a and 231b. The internal gear 232 includes an internal gear portion 232a with which the planetary gears 231a and 231b engage and an output-side gear portion 232b that engages with the interface gear 217.

In the planetary gear unit 230, when the switching lever 236 is latched in the hook portion 234c of the sun gear 234 to constrain the rotation of the sun gear 234, the rotation of the carrier gear 233 is transmitted to the internal gear 232 on the output side. In the case that the switching lever 236 does not constrain the rotation of the sun gear 234, the rotation of the carrier gear 233 is not transmitted to the internal gear 232.

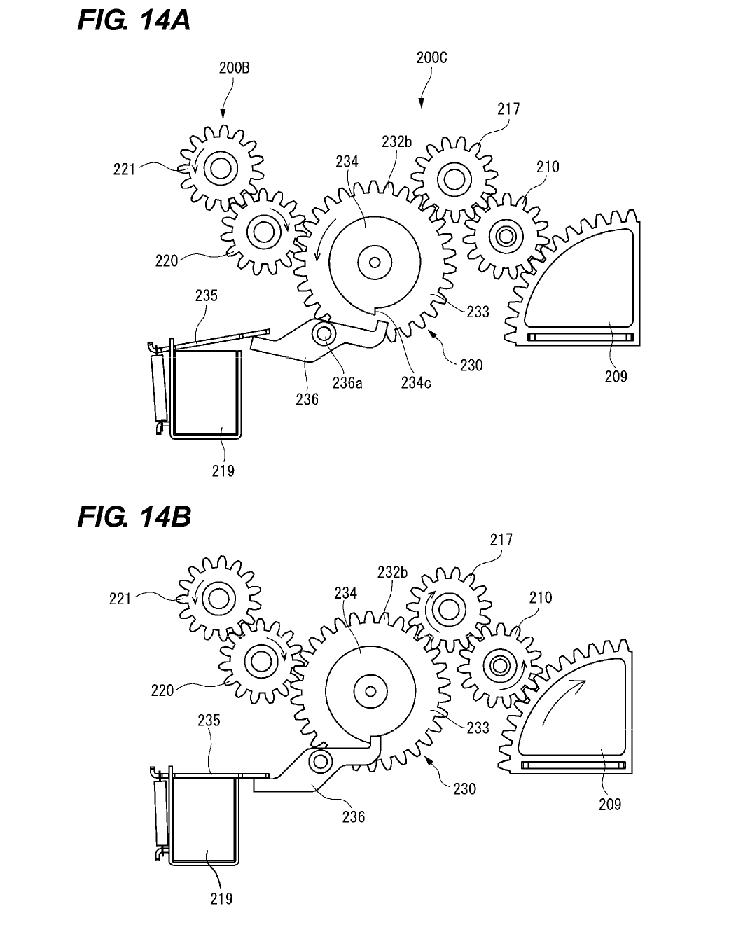

The lifting operation of the stacking plate 206 of the sheet feeding device 20 including the planetary gear unit 230 will be described below. FIG. 14A illustrates the initial state of the drive transmission portion 200B when the sheet feeding cassette 201 is mounted on the printer body 101A. Because the top surface of the sheet is separated from the pickup roller in the initial state, it is necessary to lift the stacking plate to the sheet feedable position of the pickup roller to press the sheet against the pickup roller.

When the signal is input to the controller 8 from the mounting sensor 300 sensing that the sheet feeding cassette 201 is mounted on the printer body 101A, the controller 8 rotates the driving motor 227 to rotate the lifter mechanism driving gear 221, thereby rotating the conveying roller 250 and the driven roller 252. When the lifter mechanism driving gear 221 rotates, the idler gear 220 engaging with the lifter mechanism driving gear 221 rotates, and therefore the carrier gear 233 engaging with the idler gear 220 rotates in the planetary gear unit 230.

However, at this point, the rotation of the sun gear 234 is not constrained because the switching lever 236 is not latched in the hook portion 234c provided in the cam portion 234b of the sun gear 234. In this case, although the drive of the idler gear 220 is transmitted to the carrier gear 233, the rotation of the carrier gear 233 is not transmitted to the internal gear 232, and the interface gear 217 does not rotate.

Then, the controller 8 applies the voltage to the solenoid 219 at the time the feed of the sheet S is started. Therefore, as illustrated in FIG. 14B, the constraining member 235 presses the switching lever 236 to swing the switching lever 236, and the switching lever 236 is latched in the hook portion 234c of the cam portion 234b of the sun gear 234 to constrain the rotation of the sun gear 234.

When the rotation of the sun gear 234 is constrained, the drive is transmitted to the internal gear 232 to rotate the internal gear 232, and the interface gear 217 engaging with the output-side gear portion 232b of the internal gear 232 rotates. When the interface gear 217 rotates, the rotation of the interface gear 217 is transmitted to the lifter gear 209 through the cassette interface gear 210, and the lifter gear 209 rotates in the arrow direction.

Therefore, the lifter plate 208 turns upward with the bearing 211 as the support point, and the stacking plate 206 is pushed up about the support shaft 213 to lift the sheet S. Immediately after the sheet feeding cassette 201 is mounted, it is necessary that the stacking plate 206 move over a long distance to the sheet feedable position. For this reason, the controller 8 continuously applies the voltage to the solenoid 219 to lift the stacking plate 206.

After the stacking plate 206 is lifted to the sheet feedable position, the controller 8 drives the sheet feeding motor M to rotate the pickup roller 202, thereby feeding the sheet S. When the sheet S is repeatedly fed, the level of the top surface of the sheets S decreases gradually. With decreasing level of the top surface, the support member 205 turns downward together with the pickup roller 202, and the position sensor 224 eventually becomes the transmissible state. At this point, the controller 8 applies the voltage to the solenoid 219.

The time for which the voltage is applied to the solenoid 219 is set within the time for one revolution of the sun gear 234. Therefore, the rotation amount of the lifter gear 209 is kept constant because the constant amount of drive is transmitted to the lifter gear 209. In the case that the sheets S are continuously fed, the rotation of the sun gear 234 is constrained for a constant time based on the signal from the position sensor 224, whereby the rotation amount of the lifter gear 209 is kept constant. As a result, the stacking plate 206 can be lifted by a constant amount, and the top surface of the sheets S can be held at the substantially constant level.

As described above, in the third embodiment, when the sheet feeding cassette 201 is mounted, or when a predetermined number of sheets S are fed, the rotation of the sun gear 234 is constrained to selectively transmit the drive of the driving motor 227 to the lifter gear 209. Therefore, the stacking plate 206 can be lifted by the predetermined amount without use of the dedicated lifter motor.

In the configuration of the third embodiment, stacking plate 206 is lifted by rotating the sun gear 234 once. Alternatively, the number of hook portions of the sun gear 234 is increased, and the time for which the voltage is applied to the solenoid 219 may be decreased to finely control the S lifting amount of the stacking plate 206. The lifting amount of the stacking plate 206 per one revolution can be changed by changing the reduction ratio of the gear train.

While the present invention has been described with reference to exemplary embodiments, it is to be understood that the invention is not limited to the disclosed exemplary embodiments. The scope of the following claims is to be accorded the broadest interpretation so as to encompass all such modifications, equivalent structures, and functions.

This application claims the benefit of Japanese Patent Application No. 2013-178990, filed Aug. 30, 2013, which is hereby incorporated by reference herein in its entirety.

What is claimed is:

1. An image forming apparatus comprising:
an image forming portion that forms an image on a sheet;
a sheet storage portion that is drawably mounted on an apparatus body, the sheet storage portion including a sheet stacking portion that stacks a sheet and is able to lifted and a lifting portion that lifts the sheet stacking portion;
a sheet feeding portion that feeds a sheet while abutting the sheet on a sheet stacked on the lifted sheet stacking portion;
a driving portion that drives a driven portion;
a body-side lifting portion that is provided in the apparatus body to engage with the lifting portion of the sheet storage portion mounted on the apparatus body;
a drive transmission portion that is provided between the driving portion and the body-side lifting portion, the drive transmission portion selectively transmitting drive of the driving portion to the lifting portion of the sheet storage portion through the body-side lifting portion to lift the sheet stacking portion, the drive of the driving portion being transmitted to the driven portion; and
a controller that controls the drive transmission portion.

2. The image forming apparatus according to claim 1, wherein, with decreasing number of sheets during feed of the sheet, the controller controls the drive transmission portion such that the drive of the driving portion lifts the sheet stacking portion by a constant amount.

3. The image forming apparatus according to claim 1, wherein the drive transmission portion includes: a missing tooth gear; and a switching portion that switches the missing tooth gear between a state in which the drive of the driving portion is not transmitted to the lifting portion of the sheet storage portion and a state in which the drive of the driving portion is transmitted to the lifting portion of the sheet storage portion, and
the control portion controls the switching portion such that the missing tooth gear is switched to the state in which the drive of the driving portion is transmitted to the lifting portion of the sheet storage portion.

4. The image forming apparatus according to claim 3, wherein the controller controls the switching portion such that the sheet stacking portion is lifted to a position where the sheet abuts on the sheet feeding portion when the sheet storage portion is mounted on the apparatus body, and such that the sheet stacking portion is lifted by a predetermined amount when a predetermined number of sheets are fed.

5. The image forming apparatus according to claim 1, wherein the drive transmission portion includes: a planetary gear mechanism; and a switching portion that switches the planetary gear mechanism between a state in which the drive of the driving portion is not transmitted to the lifting portion of the sheet storage portion and a state in which the drive of the driving portion is transmitted to the lifting portion of the sheet storage portion, and
when the sheet storage portion is mounted on the apparatus body, the controller controls the switching portion such that the planetary gear mechanism is switched to the state in which the drive of the driving portion is transmitted to the lifting portion of the sheet storage portion.

6. The image forming apparatus according to claim 5, wherein the controller controls the switching portion such that the sheet stacking portion is lifted to a position where the sheet abuts on the sheet feeding portion when the sheet storage portion is mounted on the apparatus body, and such that the sheet stacking portion is lifted by a predetermined amount when a predetermined number of sheets are fed.

7. The image forming apparatus according to claim 3, wherein the lifting portion includes: a turning member that is turnable in a vertical direction in which the sheet stacking portion is lifted; and a lifting gear that is provided on a turning shaft of the turning member, and
the lifting portion of the sheet storage portion includes a gear train that transmits the selectively-transmitted drive of the driving portion to the lifting gear.

8. The image forming apparatus according to claim 7, wherein the numbers of teeth of the missing tooth gears, the lifting gears, and the gear train are set such that the sheet stacking portion is lifted by a predetermined amount before the missing tooth gear rotates once.

9. The image forming apparatus according to claim 1, wherein the driven portion is a pair of conveying rollers that conveys the sheet fed from the sheet feeding portion toward the image forming portion, and
the driving portion is a driving motor that drives the pair of conveying rollers.

10. An image forming apparatus comprising:
an image forming portion that forms an image on a sheet;
a sheet storage portion that is drawably mounted on an apparatus body, the sheet storage portion including a sheet stacking portion that stacks a sheet and is able to be lifted and lowered and a lifting portion that lifts the sheet stacking portion;
a sheet feeding portion that feeds a sheet while abutting the sheet on a sheet stacked on the lifted sheet stacking portion;
a driving portion that is provided in the apparatus body to drive a predetermined driven portion provided in the apparatus body;
a body-side lifting portion that is provided in the apparatus body to engage with the lifting portion of the sheet storage portion mounted on the apparatus body;
a drive transmission portion that is provided between the driving portion and the lifting portion of the sheet storage portion to selectively transmit drive of the driving portion to the lifting portion of the sheet storage portion; and
a controller that controls the drive transmission portion such that the drive of the driving portion is selectively transmitted to the lifting portion of the sheet storage portion through the body-side lifting portion.

11. The image forming apparatus according to claim 10, wherein, with decreasing number of sheets during feed of the sheet, the controller controls the drive transmission portion such that the drive of the driving portion lifts the sheet stacking portion by a constant amount.

12. The image forming apparatus according to claim 10, wherein the drive transmission portion includes: a missing tooth gear; and a switching portion that switches the missing tooth gear between a state in which the drive of the driving portion is not transmitted to the lifting portion of the sheet storage portion and a state in which the drive of the driving portion is transmitted to the lifting portion of the sheet storage portion, and
the controller controls the switching portion such that the sheet stacking portion is lifted to a position where the sheet abuts on the sheet feeding portion when the sheet storage portion is mounted on the apparatus body, and such that the sheet stacking portion is lifted by a predetermined amount when a predetermined number of sheets are fed.

13. The image forming apparatus according to claim 10, wherein the drive transmission portion includes: a planetary gear mechanism; and a switching portion that switches the planetary gear mechanism between a state in which the drive of the driving portion is not transmitted to the lifting portion of the sheet storage portion and a state in which the drive of the driving portion is transmitted to the lifting portion of the sheet storage portion, and
the controller controls the switching portion such that the sheet stacking portion is lifted to a position where the sheet abuts on the sheet feeding portion when the sheet storage portion is mounted on the apparatus body, and such that the sheet stacking portion is lifted by a predetermined amount when a predetermined number of sheets are fed.

14. The image forming apparatus according to claim 9, wherein the driven portion is a pair of conveying rollers that conveys the sheet fed from the sheet feeding portion toward the image forming portion, and
the driving portion is a driving motor that drives the pair of conveying rollers.
